(19) United States
(12) Patent Application Publication
(10) Pub. No.: US 2005/0134998 A1
(43) Pub. Date: Jun. 23, 2005

(54) Pole base assembly for magnetic recording and reproducing apparatus and the magnetic recording and reproducing apparatus employing the same

(75) Inventor: Young-ho Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/014,852

(22) Filed: Dec. 20, 2004

(30) Foreign Application Priority Data
Dec. 23, 2003 (KR) 2003-95752

(51) Int. Cl. G11B 5/027

(52) U.S. Cl. 360/85

(57) ABSTRACT

A pole base assembly for a magnetic recording and reproducing apparatus has a base member disposed on a deck and adapted to be moved toward the head drum at the time of loading the magnetic tape. A pole member is secured to the top surface of the base member and guides the magnetic tape to run at an angle in a section where the magnetic tape contacts the head drum. A top edge guide member is disposed at the top end of the pole member and has a flange adapted to contact the top edge of the magnetic tape when the magnetic tape is running in contact with the pole member and moves toward the top end of the pole member. Since the upward and downward movement of the magnetic tape may be guided with the pole member, use of a conventional guide roller may be eliminated. Accordingly, manufacturing costs and steps for a magnetic recording and reducing apparatus may be reduced.

### CROSS-REFERENCE TO RELATED APPLICATIONS

This application claims the benefit under 35 U.S.C. § 119(a) of Korean Patent Application No. 2003-95752 filed on Dec. 23, 2003 in the Korean Intellectual Property Office, the entire disclosure of which is hereby incorporated by reference.

### BACKGROUND OF THE INVENTION

1. Field of the Invention

The present invention relates to a magnetic recording and reproducing apparatus. More particularly, the present invention relates to a pole base assembly for a magnetic recordingand reproducing apparatus that is adapted to move a magnetic tape into close contact with a head drum at the time of loading of the magnetic tape and to run in close contact with the head drun during running of the magnetic tape. The present invention also relates to a magnetic recording and reproducing apparatus employing such a pole base assembly.

2. Description of the Related Art

Typically, a magnetic recording and reproducing apparatus having a deck mechanism, such as a video tape recorder (VTR) or a camcorder, is an apparatus for recording data into and reproducing data from a magnetic tape while the magnetic tape is running along a predetermined route formed within the deck.

FIG. 1 shows a deck typically employed in a camcorder among magnetic recording and reproducing apparatuses as described above. A conventional deck 100 includes a deck chassis 10, a head drum 30, and a pair of pole base assemblies 50. In the drawing, reference numerals 40, 60 and 70 respectively indicate a tension pole assembly, a pinch roller, and a review pole assembly, which form a running route of a magnetic tape, and reference numeral 80 indicates a capstan drive unit for providing power required for the running of the magnetic tape.

The deck chassis 10 forms the outer wall of the deck 100 and various driving components for recording and reproducing of data, such as the head drum 30, the pole base assemblies 50, etc., are disposed in the deck chassis 10.

The head drum 30 records data onto a magnetic tape 1 running within the deck 10 or reproduces the data recorded in the magnetic tape 1. As is well-known in the art, such a head drum 30 is installed to be slanted by a predetermined angle θ (see FIG. 6) in relation to a reference surface H (see FIG. 6), which is parallel to the bottom surface of the deck chassis 10, so that recording/reproducing of data may be efficiently implemented.

Each pole base assembly 50 draws the magnetic tape 1 out of a tape cassette 90 at the time of loading the magnetic tape 1 to bring the magnetic tape 1 into close contact with the head drum 230 and to guide the magnetic tape 1 to run while being in contact with the head drum 30.

The conventional pole base assembly 50 includes a base member 51, a pole member 53, and a guide roller 55 as shown in FIG. 2. The base member 51 is slidably installed on a guide rail 11 provided on the deck chassis 10. With this arrangement, the base member 51 is moved along the direction indicated by arrow A to a loading position PI (see FIG. 1) adjacent to the head drum 30. The pole member 53 and the guide roller 55 extend from the top surface of the base member 51 and are moved into contact with the magnetic tape 1 at the time of loading the magnetic tape 1, thereby bringing the magnetic tape 1 into close contact with the head drum 30. In addition, when the magnetic tape runs after the completion of the loading of the magnetic tape 1, the pole member 53 and the guide roller 55 guide the running of the magnetic tape 1 so that the magnetic tape 1 runs in close contact with the head drum 30. Here, the pole member 53 is installed to be positioned parallel to the circumferential surface of the head drum 30, which is installed to be slanted in relation to the bottom surface of the deck chassis 10 in the state in which the loading of the magnetic tape 1 has been completed. By the pole member 53, the running direction of the magnetic tape 1 is diverted to the head drum 30 side. The guide roller 55 serves to align the top and bottom positions of the magnetic tape 1 prior to contacting the pole member 53 and includes upper and lower flanges 57 and 56 to contact the top and bottom edges of the magnetic tape 1, respectively.

With the conventional deck 100 configured as described above, each of the pole base assemblies 50 are provided with both the pole member 53 and the guide roller 55, as shown in FIG. 2. Therefore, there is a problem in that it is not easy to reduce the manufacturing costs and steps for such a magnetic recording and reproducing apparatus. In addition, there is also a problem in that it is difficult to miniaturize such a magnetic recording and reproducing apparatus.

### SUMMARY OF THE INVENTION

Accordingly, an object of the present invention is to provide a pole base assembly for a magnetic recording and reproducing apparatus and a magnetic recording and reproducing apparatus employing such a pole base assembly.The pole base assembly is improved in construction to reduce the manufacturing costs and steps for the magnetic recording and reproducing apparatus and realizing the miniaturization of the magnetic recording and reproducing apparatus.

In order to achieve the above-mentioned object, a pole base assembly for a magnetic recording and reproducing apparatus includes a base member provided on a deck adapted to be moved toward the head drum at the time of loading the magnetic tape. A pole member is secured to the top surface of the base member and guides the magnetic tape to angularly run in a section where the magnetic tape contacts the head drum. A top edge guide member is disposed at the top end of the pole member and has a flange adapted to contact the top edge of the magnetic tape when the magnetic tape is running while in contact with the pole member and is moving toward the top end of the pole member.

With this arrangement, the pole member may guide the upward and downward movement of the magnetic tape in place of a conventional guide roller, whereby the manufacturing costs and steps for a magnetic recording and reproducing apparatus may be reduced. In addition, such a magnetic recording and reproducing apparatus may be easily miniaturized.

According to a preferred embodiment, it is preferable that the pole member is angularly connected to the top surface of the base member in such a way that the circumferential surface of the pole member contacting the magnetic tape is parallel to the rotational axis of the head drum when the loading of the magnetic tape has been completed. Preferably, the flange of the top edge guide member is formed to be slanted in relation to the circumferential surface of the pole member in such a way that the flange is parallel to the running direction of the magnetic tape in the section where the magnetic tape and the head drum are in contact with each other.

The top edge guide member preferably has a posture maintaining means to substantially prevent the pole member from being rotated in relation to the top edge guide member. The posture retaining means includes a guide pin extending from one side of the top edge guide member and a guide projection extending from the base member by a predetermined height and connected with the guide pin to prevent the top edge guide member from being rotated in relation to the pole member.

Preferably, the guide pin and the guide projection are slidably engaged in a direction parallel to the main axial direction of the pole member.

Preferably, the pole member has a threaded part formed at the bottom end thereof to be threaded into a fixing hole formed in the top surface of the base memberand the threaded part is subjected to anti-release treatment. The fixing hole has female threads formed on the internal surface of the fixing hole is cut by the male-threads of the threaded part when F the threaded part is press-fitted into the fixing hole.

In addition, a fixing projection and a fixing slot are formed at the bottom end of the thread part and the fixing hole, respectively, in such a way that they are press-fitted with each other when the threaded part is threaded into the fixing hole.

With this arrangement, the slant angle and the height of the pole member may be easily adjusted at the time of connecting the pole member and the base member.

Preferably, a bottom edge guide member is integrally formed on the base member, which comes into contact with the bottom edge of the magnetic tape when the magnetic tape contacts the pole member as the magnetic tape moves toward the bottom end of the pole member.

Preferably, the bottom edge guide member and the base member are integrally formed as a molded product of synthetic resin.

Furthermore, the top surface of the bottom edge guide member preferably forms an obtuse angle with the circumferential surface of the pole member.

### BRIEF DESCRIPTION OF THE DRAWINGS

The above and other objects and features of the present invention will be more apparent from the description for certain embodiments of the present invention taken with reference to the accompanying drawings, in which:

FIG. 1 is a top plan view schematically showing the interior of a conventional deck of a magnetic recording and reproducing apparatus;

FIG. 2 is a perspective view showing the operating state of the pole base assembly of FIG. 1;

FIG. 3 is a perspective view of the interior of a deck according to a first embodiment of the present invention;

FIG. 4 is an exploded perspective view of the pole base assembly extracted from FIG. 3;

FIG. 5 is a partially exploded side view of the pole base assembly of FIG. 3;

FIG. 6 is a schematic view of of the pole base assembly of FIG. 3 extracted along the running direction of the magnetic tape; and

FIG. 7 is an exploded perspective view of a pole base assembly according to another embodiment of the present invention.

Throughout the drawings, like reference numbers will be understood to refer to like parts, components and structures.

### DETAILED DESCRIPTION OF THE PREFERRED EMBODIMENTS

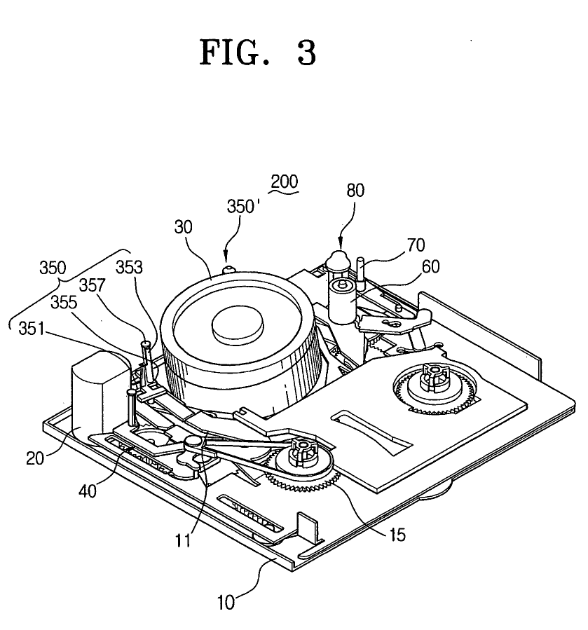

FIG. 3 is a perspective view of the interior of a deck according to a first embodiment of the present invention. Referring to FIG. 3, a deck 200 of a magnetic recording and reproducing apparatus according to a preferred embodiment of the present invention includes a deck chassis 10 and pole base assemblies 350 and 350′

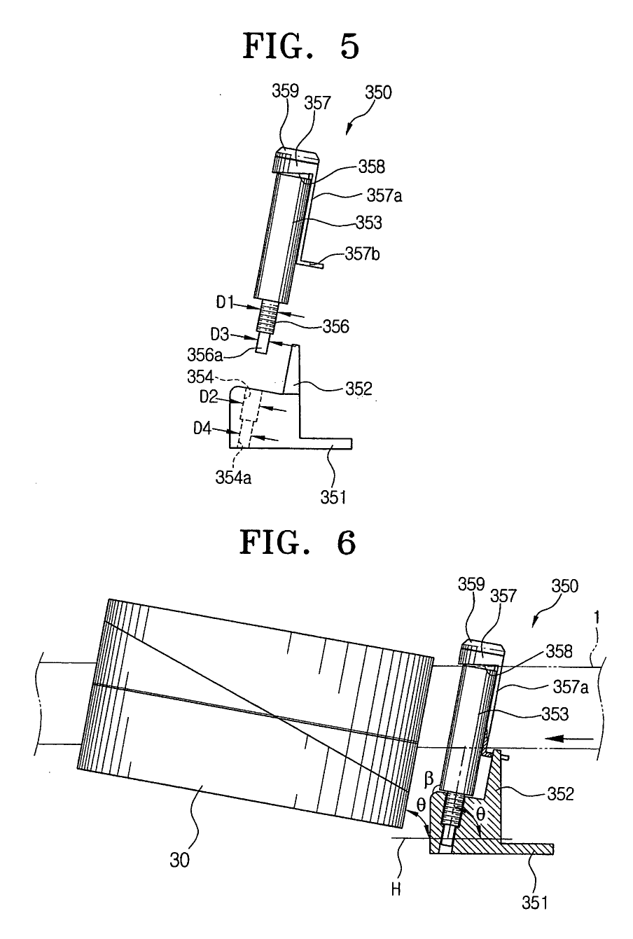

The pole base assemblies 350 and 350′ draw a magnetic tape 1 (refer to FIG. 6) out of a tape cassette 90 at the time of loading the magnetic tape 1 to bring the magnetic tape 1 into close contact with the head drum and to guide the magnetic tape 1 to run in close contact with the head drum. Pole base assemblies 350 and 350′ are installed as a pair on the deck chassis 10 to correspond to the left and right sides of the head drum 30. In general, the pole base assembly for guiding the magnetic tape 1 entering into the head drum 30 is called a “supply side pole base assembly” 350 and the pole base assembly for guiding the magnetic tape 1 discharged from the head drum 30 is called a “winding side pole base assembly” 350′. Although the present invention is applicable to both of the pair of the pole base assemblies 350 and 350′, the present invention is described with regard to the supply side pole base assembly 350 only for matters of convenience.

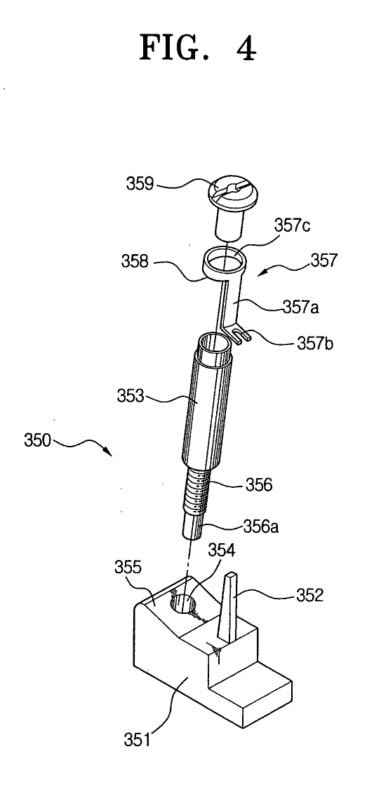

As shown in FIGS. 4 to 6, the supply side pole base assembly 350 includes a base assembly 351, a pole member 353, a first guide member 355, and a second guide member 357.

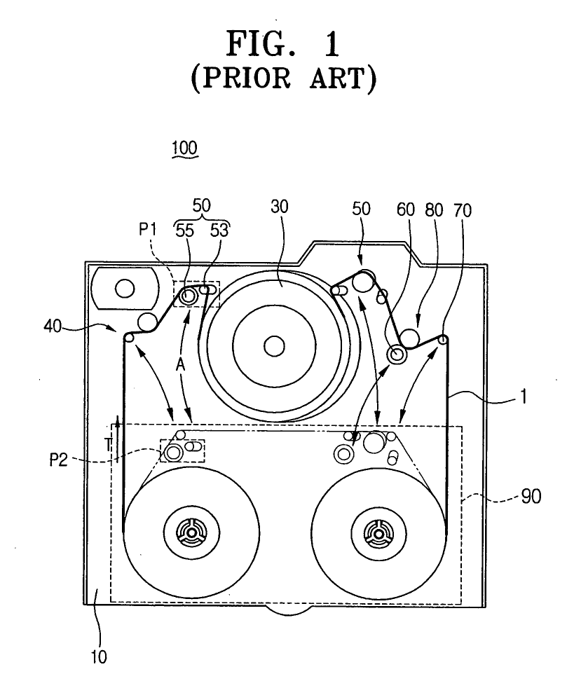

The base member 351 is moved to a loading position PI (see FIG. 1) adjacent to the head drum at the time of loading the magnetic tape 1, and the base member 351 is moved to an unloading position P2 (see FIG. 1) at the time of unloading the magnetic tape 1. Such movement of the base member 351 is provided by a loading motor 20 (FIG. 3) and a connecting unit (not shown) installed on the deck to transfer the power of the loading motor to the base member 351. Because the specific construction of the loading motor 20 and the connecting unit are well-known in the art, the detailed description thereof is omitted. Meanwhile, reference numeral 354 indicates a fixing hole into which threads 356 formed on the bottom end of a pole member 353 are engaged for connecting the pole member 353 and the base member 351. In addition, reference numeral 352 indicates a guide projection slidably connected with a guide pin 357a to be described later.

The pole member 353 is secured to the top surface of the base member 351 and moved with the base member 351 at the time of loading the magnetic tape 1 (see FIG. 6) to urge the magnetic tape 1 to come into close contact with the head drum 30. When the magnetic tape I runs after the completion of the loading of the magnetic tape, the pole member 353 guides the magnetic tape 1 to run in close contact with the head drum 30.

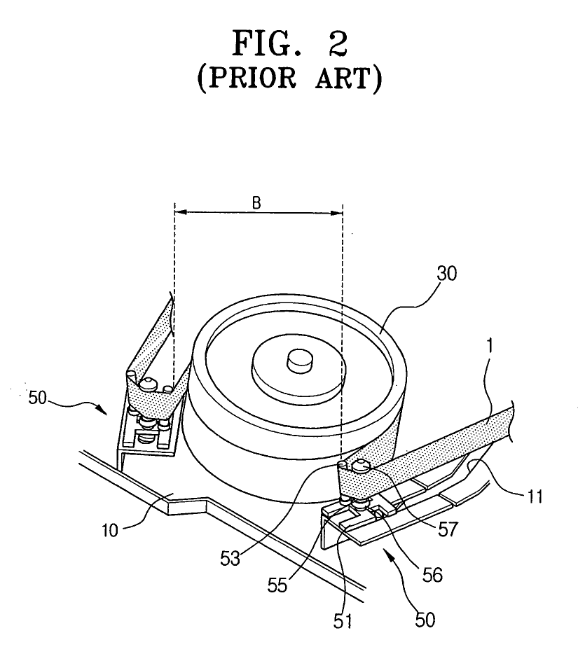

The pole member 353 according to the present embodiment is angularly secured to the top surface of the base member 351. This is because the head drum 30 is angularly installed on the deck chassis 10. The running posture of the magnetic tape 1 in a section B (refer to FIG. 2) where the magnetic tape 1 is contacted with the head drum 30 is angled with respect to the running posture thereof in other sections. Thus, the pole member 353 is preferably installed to be angled with respect to the bottom surface of the deck chassis 10 so that the circumferential surface is parallel to the parts of the circumferential surface of the head drum 30 where the contact between the magnetic tape 1 and the head drum 30 is initiated and terminated. The magnitude of the angle formed between the pole member 353 and the base member 351 may be varied according to the shape of the guide rail 11 (see FIG. 3) for guiding the movement of the base member 351 at the time of loading and unloading of the magnetic tape 1. Although not shown in the drawings, if the base member 351 is angularly guided to correspond to the circumferential surface of the head drum 30 by the guide rail 11 at the time of loading the magnetic tape 1, preferably, the pole member 353 and the base member 351 are substantially perpendicular to one another. If the base member 351 is moved parallel to the bottom surface of the deck chassis 10 at the time of loading and unloading of the magnetic tape 1, the pole member 353 is installed on the base member 351 forming an angle θ between the circumferential surface of the head drum 30 and the deck chassis 10, as shown in FIG. 5.

In order to angularly connect the pole member 353 on the base member 351, the pole base assembly 350 according to the present embodiment includes a threaded part 356 formed at the bottom end of the pole member 353 and a fixing hole 354 formed in the base member 351. The threaded part 356 is formed in a taptite shape subjected to anti-release treatment. In addition, the male threads of the threads part 356 form female threads on the internal circumferential surface of the fixing hole 354 by cutting the internal circumferential surface of the fixing hole 354 when the threaded part 356 press-fitted into the fixing hole 354. For this purpose, it is preferred that the inner diameter D2 of the fixing hole 354 is somewhat smaller than the outer diameter D1 of the threaded part 356. With the screw connection between the threaded part 356 and the fixing hole 354, it is easy to set the height of the pole member 353 with reference to the base member 351. In addition, because the threaded part 356 is formed in the taptite shape, it is possible to prevent the threaded part from being reversely rotated due to an external impact or vibration, thereby preventing variation of the height of the pole member 353. Meanwhile, according to the present embodiment, a fixing projection 356a is extended from the bottom end of the threaded part 356, and the bottom surface of the fixing hole 354 is additionally formed with a fixing slot 354a (see FIG. 5). The fixing projection 356a and the fixing slot 354a guide the threaded part 356 and the fixing hole 354 at the time of fitting the threaded part 356 into the fixing hole 354 so that the angle of the pole member 353 and the base member 351 may be correctly set. Preferably, the outer diameter D3 of the fixing projection 356a is formed to be somewhat larger than the inner diameter D4 of the fixing slot 354a so that an interference fit is formed between the fixing projection and the fixing slot prior to the threaded part 356 and the fixing hole 354 being engaged with each other. Therefore, the angle between the pole member 353 and the base member 351, as well as the height of the pole member 353 with reference to the base member 351, may be correctly set at the time of connecting the pole member 353 and the base member 351. To facilitate the connection of the threaded part 356 and the fixing hole 354, preferablythe base member 351 is formed as a molded product of synthetic resin. Since a small amount of force is required to connect the fixing hole 354 and the threaded part 356, the adjustment of the height and slant angle may be manually performed with ease by an operator.

The pole base assembly 350 includes first and second guide members 355 and 357 to eliminate the conventional guide roller 55 (see FIG. 1). With the first and second guide members 355 and 357, it is possible to prevent the magnetic tape 1 from being moved along the direction parallel to the rotational axis of the head drum 30. As a result, it is possible to omit the conventional guide roller 55 (see FIG. 1).

The first guide member 355 is integrally formed on the top surface of the base member 351 and comes into contact with the bottom edge of the magnetic tape 1 when the magnetic tape 1 is moved toward the bottom end of the pole member 353. The first guide member 355 and the base member 351 are preferably formed as molded products of synthetic resin so that the first guide member 355 and the base member 351 may easily be integrally formed with each other. In addition, it is preferable that the first guide member 355 and the circumferential surface of the pole member 353 form an obtuse angle therebetween. Considering the guiding of the bottom edge of the magnetic tape 1, preferably the angle formed between the first guide member 355 and the circumferential surface of the pole member 353 is about 90 degrees to 130 degrees. With this arrangement, the magnetic tape 1 returns to the center of the pole member 353, thereby avoiding damaging the magnetic tape.

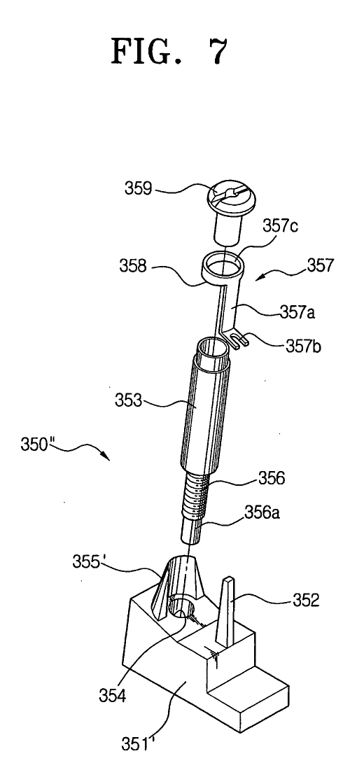

A part of the top surface of the base member 351 adjacent to the bottom end of the pole member 353 is used as the first guide member 355. The guide rail 11 is formed parallel to the reference surface H (see FIG. 6), so that the base member 351 is moved parallel to the deck chassis 10. The pole member 353 is angularly connected to the base member 351. The pole member 353 is capable of always retaining an angled position in relation to the deck chassis 353 as shown in FIG. 3 at the time of loading, unloading and running of the magnetic tape 1, so that the magnetic tape 1 tends to move only toward the top of the pole member 353 at the time of loading, unloading and running of the magnetic tape 1. If the pole base assembly 350 and the guide rail 11 are formed in such a way that the pole member 353 cannot retain the angled position in relation to the deck chassis in at least a section of its course, the first guide member 355′ preferably extends to a predetermined height from the base member 351′ of the pole base assembly 350″ according to a second embodiment of the present invention, as shown in FIG. 7. In this event, the guide member 355′ may be formed in various suitable forms without being limited to the form shown in the drawingto prevent the downward movement of the magnetic tape 1.

The second guide member 357 is provided at the top end of the pole member 357 and is provided with a flange 358 adapted to contactthe top edge of the magnetic tape 1 as it moves toward the top end of the pole member 353. Here, the flange 358 of the second guide member 357 is formed parallel to the running direction of the magnetic tape 1 in the section B (see FIG. 2) where the head drum 30 and the magnetic tape 1 are in contact with each other. Preferably, the flange 358 of the second guide member 357 is formed at an angle in relation to the circumferential surface of the pole member 353. However, it is not necessary to form the bottom surface of the flange 353 to be entirely slanted. That is, as shown in FIG. 5, it is sufficient if only a part corresponding to a section of the pole member 353 contacts the magnetic tape 1 at the time of loading, unloading and running of the magnetic tape 1 is angularly formed. The remaining part except the angularly formed part may be formed in various forms only if it does not cause any problems at the time of running of the magnetic tape 1 and in configuring the deck 200.

The second guide member 357 as described above is secured to the top end of the pole member by press-fitting the pole member 353 into the connecting hole 357c formed at the center of the second guide member 357. In addition, the second guide member 357 is enclosed by the cover member 359 at its top endto prevent the second guide member from breaking away from an upper part of the pole member 353.

Since the second guide member 357 and the pole member 353 are connected with each other, the pole base assembly 350 according to the present embodiment further comprises a posture retaining means to prevent the second guide member 357 from being rotated in relation to the pole member 353. The posture retaining means prevents the magnetic tape 1 from being incorrectly guided as the flange 353 formed to be angled in relation to the pole member 353 is rotated at the tope end of the pole member 353 The posture retaining means includes a guide pin 357a and a guide projection 352. A guide slit 357b is formed at the tip end of the guide pin 357a, and the guide slit 357b is slidably connected with the guide projection 352 extending from the base member 351. With this arrangement, the guide slit 357b and the guide projection 352 are substantially prevented from being separated from each other even when the height is varied by adjusting the thread connection between the threaded part 356 and the fixing hole 354.

In the above, the present invention has been described only in terms of the supply side pole base assembly 350 among a pair of pole base assemblies 350 and 350′. However, because the winding side pole base assembly 350′ is substantially similar to the supply side pole base assembly 350 in construction, the present invention is also applicable to the winding side pole base assembly 350′.

In addition, although the present invention has been described with reference to a deck of a camcorder by way of an example, the present invention is also applicable to a deck of a magnetic recording and reproducing apparatus of another type, such as a vide tape recorder (VTR) if such a deck includes a pole base assembly with a pole base and a base member as described above.

According to the present invention as described above, the first and second guide members 355, 355′ and 357 are provided at the top and bottom ends of the pole member 353 of the pole base assemblies 350, 350′ and 350″, respectively, to guide the upward and downward movement of the magnetic tape. Accordingly, it is not required to provide a separate member, such as a conventional guide roller 55 (refer to FIG. 1) to align the top and bottom positions of the tape. In addition, because the second guide members 355 and 355′ are integrally formed on the base members 351 and 351′, the base member 351, 351′ and the second guide member 355 and 355′ can be more easily formed. As a result, a magnetic recording and reproducing apparatus may be easily miniaturized as well reducing the manufacturing costs and steps for a magnetic recording and reproducing apparatus can be reduced.

While the preferred embodiments of the present invention have been shown and described in order to exemplify the principle of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

1. A pole base assembly for a magnetic recording and reproducing apparatus that brings a magnetic tape into close contact with a head drum at the time of loading the magnetic tape and guides the magnetic tape to run in close contact with the head drum, the pole base assembly comprising:
a base member provided on a deck and adapted to be movable toward the head drum at the time of loading the magnetic tape;
a pole member secured to the top surface of the base member and guiding the magnetic tape to angularly run in a section where the magnetic tape contacts the head drum; and
a top edge guide member disposed at a top end of the pole member and having a flange adapted to contact the top edge of the magnetic tape when the magnetic tape is contacting the pole member as the magnetic tape moves toward the top end of the pole member.

2. A pole base assembly as claimed in claim 1, wherein
the pole member is angularly installed on the top surface of the base member, a circumferential surface of the pole member being parallel to a rotational axis of the head drum when the loading of the magnetic tape is completed.

3. A pole base assembly as claimed in claim 2, wherein
the flange of the top edge guide member is angled with respect to the circumferential surface of the pole member, and the flange is parallel to the running direction of the magnetic tape in the section where the magnetic tape and the head drum are in contact with each other.

4. A pole base assembly as claimed in claim 3, wherein
the top edge guide member has a posture maintaining means to substantially prevent the pole member from being rotated in relation to the top edge guide member.

5. A pole base assembly as claimed in claim 4, wherein
the posture retaining means includes
a guide pin extending from one side of the top edge guide member; and
a guide projection extending from the base member by a predetermined height and engaging the guide pin to prevent the top edge guide member from being rotated in relation to the pole member.

6. A pole base assembly as claimed in claim 5, wherein
the guide pin and the guide projection are slidingly engaged in a direction parallel to a main axial direction of the pole member.

7. A pole base assembly as claimed in claim 3, wherein
the pole member has a threaded part formed at the bottom end thereof to be threaded into a fixing hole formed in the top surface of the base member, and
the fixing hole has female threads formed as the internal surface of the fixing hole is cut by the threaded part when the threaded part is press-fitted into the fixing hole.

8. A pole base assembly as claimed in claim 7, wherein
the threaded part is subjected to anti-release treatment.

9. A pole base assembly as claimed in claim 7, wherein
a fixing projection and a fixing slot are formed at the bottom end of the thread part and the fixing hole, respectively, the fixing projection and the fixing slot being press-fitted together when the threaded part is threaded into the fixing hole.

10. A pole base assembly as claimed in claim 3, wherein
a bottom edge guide member is adapted to contact a bottom edge of the magnetic tape when the magnetic tape contacting the pole member moves toward the bottom end of the pole member.

11. A pole base assembly as claimed in claim 10, wherein
a top surface of the bottom edge guide member connected to the pole member is at an obtuse angle with the circumferential surface of the pole member.

12. A pole base assembly as claimed in claim 10, wherein
the bottom edge guide member is integrally formed on the base member.

13. A pole base assembly as claimed in claim 12, wherein
the base member is a molded product of synthetic resin.

14. A magnetic recording and reproducing apparatus, comprising:
a head drum installed within a deck to record data into a magnetic tape running within the deck or to read data recorded in the magnetic tape;
a pole base assembly to bring a magnetic tape into close contact with the head drum at a time of loading the magnetic tape and to guide the magnetic tape to run in close contact with the head drum, the pole base assembly including
a base member disposed on the deck and adapted to be movable toward the head drum at the time of loading the magnetic tape;
a pole member secured to a top surface of the base member and guiding the magnetic tape to angularly run in a section where the magnetic tape contacts the head drum; and
a top edge guide member disposed at the top end of the pole member and having a flange adapted to contact a top edge of the magnetic tape when the magnetic tape running is contacting the pole member as the magnetic tape moves toward the top end of the pole member.

15. A magnetic recording and reproducing apparatus as claimed in claim 14, wherein
the pole member is angularly installed on the top surface of the base member, a circumferential surface of the pole member being parallel to a rotational axis of the head drum when the loading of the magnetic tape is completed.

16. A magnetic recording and reproducing apparatus as claimed in claim 15, wherein
the flange of the top edge guide member is angled with respect to the circumferential surface of the pole member, and the flange is parallel to the running direction of the magnetic tape in the section where the magnetic tape and the head drum are in contact with each other.

17. A magnetic recording and reproducing apparatus as claimed in claim 14, wherein
the top edge guide member has a posture maintaining means to substantially prevent the pole member from being rotated in relation to the top edge guide member.

18. A magnetic recording and reproducing apparatus as claimed in claim 15, wherein
a bottom edge guide member is adapted to contact the bottom edge of the magnetic tape when the magnetic tape contacting the pole member moves toward the bottom end of the pole member.

19. A magnetic recording and reproducing apparatus as claimed in claim 18, wherein
the top surface of the bottom edge guide member connected to the pole member is at an obtuse angle with the circumferential surface of the pole member.

20. A magnetic recording and reproducing apparatus as claimed in claim 19, wherein
the bottom edge guide member is integrally formed on the base member.
